(19) United States
(12) Patent Application Publication
(10) Pub. No.: US 2024/0220852 A1
(43) Pub. Date: Jul. 4, 2024

(54) DETERMINING INTERPERSONAL OR BEHAVIORAL SKILLS BASED ON COURSE INFORMATION

(71) Applicant: AstrumU, Inc., Kirkland, WA (US)

(72) Inventors: Xiao Cai, Redmond, WA (US); Jim Martin, Shawnee, KS (US); Amirhossein Herandi, Kirkland, WA (US); Devin Kyser Helgeson, Federal Way, WA (US); Daniel John Davis, Shrewsbury, MA (US)

(21) Appl. No.: 18/091,698

(22) Filed: Dec. 30, 2022

(51) Int. Cl. G06N 20/00

(52) U.S. Cl. CPC G06N 20/00

(57) ABSTRACT

Embodiments are directed to determining interpersonal or behavioral skills based on course information in course offerings. One or more learning objectives may be determined from course information associated with a course such that each learning objective may be associated with a learning objective narrative. A skills model may be employed to determine one or more soft skills based on the one or more learning objective narratives. The one or more soft skills may be associated with a course profile that corresponds to the course. In response to a quality score associated with the skills model being less than a threshold value, the skills model may be retrained with one or more reference models having one or more portions based on machine learning.

### TECHNICAL FIELD

The present invention relates generally to data management, and more particularly, but not exclusively, to managing data for determining interpersonal or behavioral skills based on course information.

### BACKGROUND

Identifying persons that make good employees has long been a goal of organizations. And, in today's highly competitive global market, finding and keeping great employees is becoming more challenging. Conventionally, organizations may be forced to rely on narrow or limited criteria derived from anecdotal evidence, personal preferences, gut feelings, or the like, rather than evidence based analytics to determine if a person may be a good employee candidate. Similarly, educational institutions may want to provide educational opportunities that provide their students desirable employment opportunities. Accordingly, in some cases, educational institutions may design offerings based on their perception of the needs of desirable employers. But, not unlike employers, educational institutions may have limited access to evidence based analytics to help them design their offerings. Further, students may seek out educational institutions that to prepare them for careers with desirable employers or careers. Accordingly, educational institutions often provide course information that students may employ to evaluate if a particular course may be applicable to their career goals. Likewise, employers may review course information for courses taken by candidate employees to evaluate how well candidate employees may fit the employers' needs. Course information may describe some of the activities or skills taught by a course. However, in some cases, discerning a complete view of the skills learned from a course may be difficult for employers or students alike. Thus, it is with respect to these considerations and others that the present invention has been made.

### TO DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of Various Embodiments, which is to be read in association with the accompanying drawings, wherein:

FIG. 1 illustrates a system environment in which various embodiments may be implemented;

FIG. 2 illustrates a schematic embodiment of a client computer;

FIG. 3 illustrates a schematic embodiment of a network computer;

FIG. 4 illustrates a logical architecture of a system for determining interpersonal or behavioral skills based on course information in course offerings in accordance with one or more of the various embodiments;

FIG. 5 illustrates a logical representation of a system for determining interpersonal or behavioral skills based on course information in accordance with one or more of the various embodiments;

FIG. 6 illustrates a logical schematic of a taxonomy for determining interpersonal or behavioral skills based on course information in accordance with one or more of the various embodiments;

FIG. 7 illustrates a logical schematic of a system for determining interpersonal or behavioral skills based on course information in accordance with one or more of the various embodiments;

FIG. 8 illustrates a logical schematic of a system for determining interpersonal or behavioral skills based on course information in accordance with one or more of the various embodiments;

FIG. 9 illustrates an overview flowchart for a process for determining interpersonal or behavioral skills based on course information in accordance with one or more of the various embodiments;

FIG. 10 illustrates a flowchart for a process for determining interpersonal or behavioral skills based on course information in accordance with one or more of the various embodiments;

FIG. 11 illustrates a flowchart for a process for determining interpersonal or behavioral skills based on course information in accordance with one or more of the various embodiments; and

FIG. 12 illustrates a flowchart for a process for determining interpersonal or behavioral skills based on course information in accordance with one or more of the various embodiments.

### DETAILED DESCRIPTION OF VARIOUS EMBODIMENTS

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example, embodiments, the following terms are also used herein according to the corresponding meaning, unless the context clearly dictates otherwise.

As used herein the term, “engine” refers to logic embodied in hardware or software instructions, which can be written in a programming language, such as C, C++, Objective-C, COBOL, Java™, PHP, Perl, Python, JavaScript, Ruby, VBScript, Microsoft .NET™ languages such as C #, or the like. An engine may be compiled into executable programs or written in interpreted programming languages. Software engines may be callable from other engines or from themselves. Engines described herein refer to one or more logical modules that can be merged with other engines or applications or can be divided into sub-engines. The engines can be stored in non-transitory computer-readable medium or computer storage device and be stored on and executed by one or more general purpose computers, thus creating a special purpose computer configured to provide the engine.

As used herein the term “skills model” refers one or more data structures that encapsulate the data, rules, machine learning models, machine learning classifiers, heuristics, or instructions that may be employed to determine soft skills from course information. Skills models may include various components, such as, one or more machine learning based classifiers, heuristics, rules, pattern matching, conditions, or the like. Skills models may be provided learning objective narratives to classify if the provided learning objectives may be associated with one or more soft skills.

As used herein the term “course profile” refers to one or more data structures or records gathered together to provide information about a course. For example, a course profile may include (or reference) various course information, candidate skills, confirmed skills, scorer history, or the like. Interpersonal or behavioral skills (e.g., soft skills) associated with a course may be included in a course profile.

As used herein the term “learner profile” refers to one or more data structures or records gathered together to provide information about a student. For example, a learner profile may include (or reference) various information, such as, soft skills, hard skills, educational history, employment history, short term learning/employment goals, long term learning/employment goals, demographic data, or the like. For example, interpersonal or behavioral skills (e.g., soft skills) associated with courses completed by a learner may be included in the learner's learner profile.

As used herein the term “configuration information” refers to information that may include rule-based policies, pattern matching, scripts (e.g., computer readable instructions), or the like, that may be provided from various sources, including, configuration files, databases, user input, built-in defaults, plug-ins, extensions, or the like, or combination thereof.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to determining interpersonal or behavioral skills based on course information in course offerings. In one or more of the various embodiments, one or more learning objectives may be determined from course information associated with a course such that each learning objective may be associated with a learning objective narrative.

In one or more of the various embodiments, a skills model may be employed to determine one or more soft skills based on the one or more learning objective narratives.

In one or more of the various embodiments, the one or more soft skills may be associated with a course profile that corresponds to the course.

In one or more of the various embodiments, in response to a quality score associated with the skills model being less than a threshold value, the skills model may be retrained with one or more reference models having one or more portions based on machine learning.

In one or more of the various embodiments, determining the one or more learning objectives may include: ingesting one or more of a course syllabus or a course catalog associated with the course; providing contents of the course information to an extraction model to determine the one or more learning objections or the one or more learning objective narratives; providing the one or more learning objectives or the one or more learning objective narratives to a skills engine; or the like.

In one or more of the various embodiments, employing the skills model to determine one or more soft skills may include, providing a soft skill taxonomy associated with one or more words or one or more phrases with one or more soft skills such that soft skills include one or more of creativity, communication, collaboration, community contribution, leadership, work ethic, adaptability, problem solving, or the like.

In one or more of the various embodiments, employing one or more natural language processing actions declared in the skills model to determine the one or more soft skills based on matching the one or more learning objective narratives with a soft skill taxonomy.

In one or more of the various embodiments, the skills model may be determined based on one or more characteristics of the course information such that the one or more characteristics include one or more of a course type, a course subject matter, a syllabus format, a syllabus content, or the like.

In one or more of the various embodiments, the quality score may be determined based on one or more quality metrics associated with the skills model such that the one or more quality metrics may be collected from one or more of a user-interface that provides a user satisfaction or one or more measured user interactions with the course profile.

In one or more of the various embodiments, other course information associated with one or more courses may be employed to generate one or more skills models based on one or more of machine learning, experimental observation, configurable heuristics, or the like.

### Illustrated Operating Environment

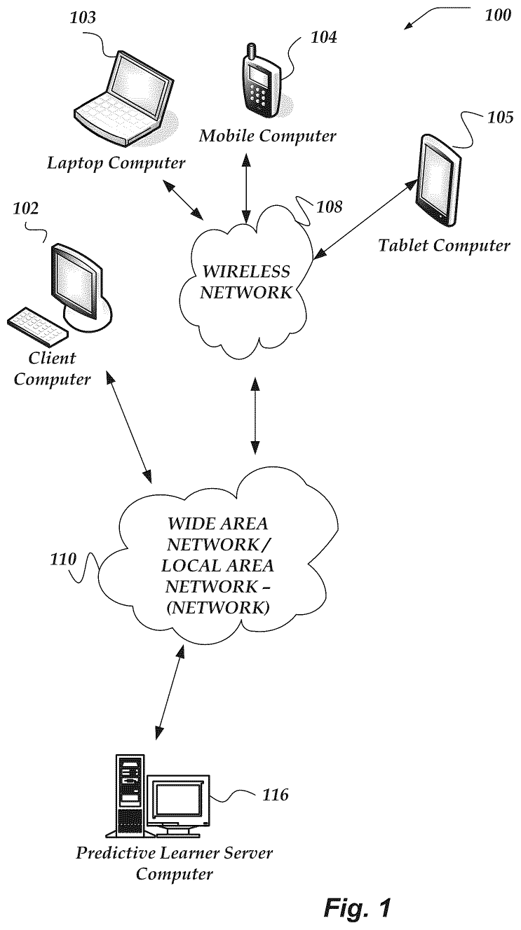

FIG. 1 shows components of one embodiment of an environment in which embodiments of the invention may be practiced. Not all of the components may be required to practice the invention, and variations in the arrangement and type of the components may be made without departing from the spirit or scope of the invention. As shown, system 100 of FIG. 1 includes local area networks (LANs)/wide area networks (WANs)-(network) 110, wireless network 108, client computers 102-105, predictive learner server computer 116, or the like.

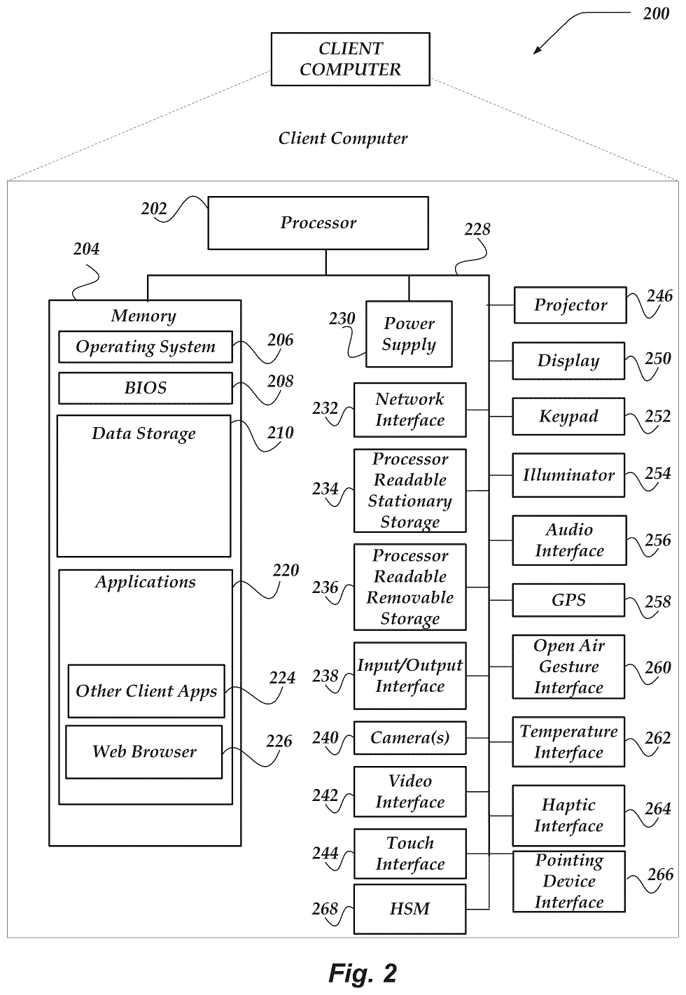

At least one embodiment of client computers 102-105 is described in more detail below in conjunction with FIG. 2. In one embodiment, at least some of client computers 102-105 may operate over one or more wired or wireless networks, such as networks 108, or 110. Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, firewall, client application, media player, mobile telephone, game console, desktop computer, or the like. However, client computers 102-105 are not constrained to these services and may also be employed, for example, as for end-user computing in other embodiments. It should be recognized that more or less client computers (as shown in FIG. 1) may be included within a system such as described herein, and embodiments are therefore not constrained by the number or type of client computers employed.

Computers that may operate as client computer 102 may include computers that typically connect using a wired or wireless communications medium such as personal computers, multiprocessor systems, microprocessor-based or programmable electronic devices, network PCs, or the like. In some embodiments, client computers 102-105 may include virtually any portable computer capable of connecting to another computer and receiving information such as, laptop computer 103, mobile computer 104, tablet computers 105, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 102-105 typically range widely in terms of capabilities and features. Moreover, client computers 102-105 may access various computing applications, including a browser, or other web-based application.

A web-enabled client computer may include a browser application that is configured to send requests and receive responses over the web. The browser application may be configured to receive and display graphics, text, multimedia, and the like, employing virtually any web-based language. In one embodiment, the browser application is enabled to employ JavaScript, HyperText Markup Language (HTML), extensible Markup Language (XML), JavaScript Object Notation (JSON), Cascading Style Sheets (CSS), or the like, or combination thereof, to display and send a message. In one embodiment, a user of the client computer may employ the browser application to perform various activities over a network (online). However, another application may also be used to perform various online activities.

Client computers 102-105 also may include at least one other client application that is configured to receive or send content between another computer. The client application may include a capability to send or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), a client certificate, or other device identifier. Such information may be provided in one or more network packets, or the like, sent between other client computers, predictive learner server computer 116, or other computers.

Client computers 102-105 may further be configured to include a client application that enables an end-user to log into an end-user account that may be managed by another computer, such as predictive learner server computer 116, or the like. Such an end-user account, in one non-limiting example, may be configured to enable the end-user to manage one or more online activities, including in one non-limiting example, project management, software development, system administration, configuration management, search activities, social networking activities, browse various websites, communicate with other users, or the like. Also, client computers may be arranged to enable users to display reports, interactive user-interfaces, or results provided by predictive learner server computer 116, or the like.

Wireless network 108 is configured to couple client computers 103-105 and its components with network 110. Wireless network 108 may include any of a variety of wireless sub-networks that may further overlay stand-alone ad-hoc networks, and the like, to provide an infrastructure-oriented connection for client computers 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, a cloud-based network, a cloud instance, or the like.

Network 110 is configured to couple network computers with other computers, including, predictive server computer 116, client computers 102, and client computers 103-105 through wireless network 108, or the like. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, Ethernet port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP).

Additionally, communication media typically embodies computer readable instructions, data structures, program modules, or other transport mechanism and includes any information non-transitory delivery media or transitory delivery media. By way of example, communication media includes wired media such as twisted pair, coaxial cable, fiber optics, wave guides, and other wired media and wireless media such as acoustic, RF, infrared, and other wireless media.

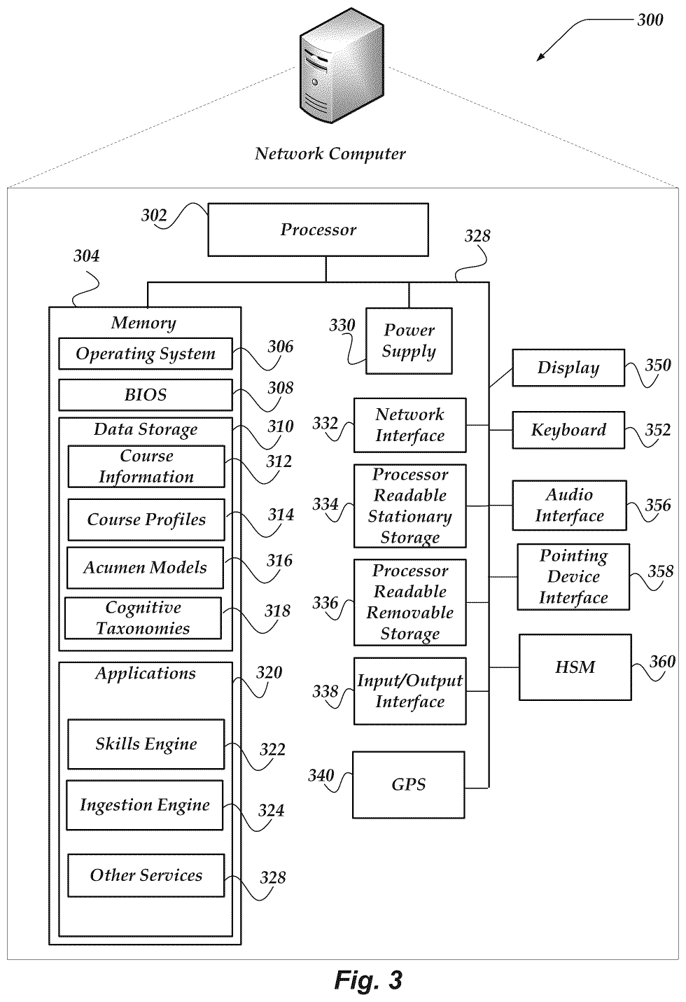

Also, one embodiment of predictive learner server computer 116 is described in more detail below in conjunction with FIG. 3. Although FIG. 1 illustrates predictive learner server computer 116, or the like, each as a single computer, the innovations or embodiments are not so limited. For example, one or more functions of predictive learner server computer 116, or the like, may be distributed across one or more distinct network computers. Moreover, in one or more embodiments, predictive learner server computer 116 may be implemented using a plurality of network computers. Further, in one or more of the various embodiments, predictive learner server computer 116, or the like, may be implemented using one or more cloud instances in one or more cloud networks. Accordingly, these innovations and embodiments are not to be construed as being limited to a single environment, and other configurations, and other architectures are also envisaged.

### Illustrative Client Computer

FIG. 2 shows one embodiment of client computer 200 that may include many more or less components than those shown. Client computer 200 may represent, for example, one or more embodiment of mobile computers or client computers shown in FIG. 1.

Client computer 200 may include processor 202 in communication with memory 204 via bus 228. Client computer 200 may also include power supply 230, network interface 232, audio interface 256, display 250, keypad 252, illuminator 254, video interface 242, input/output interface 238, haptic interface 264, global positioning systems (GPS) receiver 258, open air gesture interface 260, temperature interface 262, camera(s) 240, projector 246, pointing device interface 266, processor-readable stationary storage device 234, and processor-readable removable storage device 236. Client computer 200 may optionally communicate with a base station (not shown), or directly with another computer. And in one embodiment, although not shown, a gyroscope may be employed within client computer 200 to measuring or maintaining an orientation of client computer 200.

Power supply 230 may provide power to client computer 200. A rechargeable or non-rechargeable battery may be used to provide power. The power may also be provided by an external power source, such as an AC adapter or a powered docking cradle that supplements or recharges the battery.

Network interface 232 includes circuitry for coupling client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (NIC).

Audio interface 256 may be arranged to produce and receive audio signals such as the sound of a human voice. For example, audio interface 256 may be coupled to a speaker and microphone (not shown) to enable telecommunication with others or generate an audio acknowledgment for some action. A microphone in audio interface 256 can also be used for input to or control of client computer 200, e.g., using voice recognition, detecting touch based on sound, and the like.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication or provide light. Illuminator 254 may remain active for specific periods of time or in response to event messages. For example, when illuminator 254 is active, it may back-light the buttons on keypad 252 and stay on while the client computer is powered. Also, illuminator 254 may back-light these buttons in various patterns when particular actions are performed, such as dialing another client computer. Illuminator 254 may also cause light sources positioned within a transparent or translucent case of the client computer to illuminate in response to actions.

Further, client computer 200 may also comprise hardware security module (HSM) 268 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 268 may be a stand-alone computer, in other cases, HSM 268 may be arranged as a hardware card that may be added to a client computer.

Client computer 200 may also comprise input/output interface 238 for communicating with external peripheral devices or other computers such as other client computers and network computers. The peripheral devices may include an audio headset, virtual reality headsets, display screen glasses, remote speaker system, remote speaker and microphone system, and the like. Input/output interface 238 can utilize one or more technologies, such as Universal Serial Bus (USB), Infrared, WiFi, WiMax, Bluetooth™, and the like.

Input/output interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to client computer 200.

Haptic interface 264 may be arranged to provide tactile feedback to a user of the client computer. For example, the haptic interface 264 may be employed to vibrate client computer 200 in a particular way when another user of a computer is calling. Temperature interface 262 may be used to provide a temperature measurement input or a temperature changing output to a user of client computer 200. Open air gesture interface 260 may sense physical gestures of a user of client computer 200, for example, by using single or stereo video cameras, radar, a gyroscopic sensor inside a computer held or worn by the user, or the like. Camera 240 may be used to track physical eye movements of a user of client computer 200.

GPS transceiver 258 can determine the physical coordinates of client computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 258 can determine a physical location for client computer 200. In one or more embodiments, however, client computer 200 may, through other components, provide other information that may be employed to determine a physical location of the client computer, including for example, a Media Access Control (MAC) address, IP address, and the like.

In at least one of the various embodiments, applications, such as, operating system 206, other client apps 224, web browser 226, or the like, may be arranged to employ geo-location information to select one or more localization features, such as, time zones, languages, currencies, calendar formatting, or the like. Localization features may be used in user-interfaces, reports, as well as internal processes or databases. In at least one of the various embodiments, geo-location information used for selecting localization information may be provided by GPS 258. Also, in some embodiments, geolocation information may include information provided using one or more geolocation protocols over the networks, such as, wireless network 108 or network 111.

Human interface components can be peripheral devices that are physically separate from client computer 200, allowing for remote input or output to client computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over networks implemented using WiFi, Bluetooth™, Bluetooth LTE™, and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include web browser application 226 that is configured to receive and to send web pages, web-based messages, graphics, text, multimedia, and the like. The client computer's browser application may employ virtually any programming language, including a wireless application protocol messages (WAP), and the like. In one or more embodiments, the browser application is enabled to employ Handheld Device Markup Language (HDML), Wireless Markup Language (WML), WMLScript, JavaScript, Standard Generalized Markup Language (SGML), HyperText Markup Language (HTML), extensible Markup Language (XML), HTML5, and the like.

Memory 204 may include RAM, ROM, or other types of memory. Memory 204 illustrates an example of computer-readable storage media (devices) for storage of information such as computer-readable instructions, data structures, program modules or other data. Memory 204 may store BIOS 208 for controlling low-level operation of client computer 200. The memory may also store operating system 206 for controlling the operation of client computer 200. It will be appreciated that this component may include a general-purpose operating system such as a version of UNIX, or Linux®, or a specialized client computer communication operating system such as Windows Phone™, or the Symbian® operating system. The operating system may include, or interface with a Java virtual machine module that enables control of hardware components or operating system operations via Java application programs.

Memory 204 may further include one or more data storage 210, which can be utilized by client computer 200 to store, among other things, applications 220 or other data. For example, data storage 210 may also be employed to store information that describes various capabilities of client computer 200. The information may then be provided to another device or computer based on any of a variety of methods, including being sent as part of a header during a communication, sent upon request, or the like. Data storage 210 may also be employed to store social networking information including address books, buddy lists, aliases, user profile information, or the like. Data storage 210 may further include program code, data, algorithms, and the like, for use by a processor, such as processor 202 to execute and perform actions. In one embodiment, at least some of data storage 210 might also be stored on another component of client computer 200, including, but not limited to, non-transitory processor-readable removable storage device 236, processor-readable stationary storage device 234, or even external to the client computer.

Applications 220 may include computer executable instructions which, when executed by client computer 200, transmit, receive, or otherwise process instructions and data. Applications 220 may include, for example, client user interface engine 222, other client applications 224, web browser 226, or the like. Client computers may be arranged to exchange communications one or more servers.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), client computer 200 may include one or more hardware micro-controllers instead of CPUs. In one or more embodiments, the one or more micro-controllers may directly execute their own embedded logic to perform actions and access its own internal memory and its own external Input and Output Interfaces (e.g., hardware pins or wireless transceivers) to perform actions, such as System On a Chip (SOC), or the like.

### Illustrative Network Computer

FIG. 3 shows one embodiment of network computer 300 that may be included in a system implementing one or more of the various embodiments. Network computer 300 may include many more or less components than those shown in FIG. 3. However, the components shown are sufficient to disclose an illustrative embodiment for practicing these innovations. Network computer 300 may represent, for example, one or more embodiments of a predictive learner server computer such as predictive learner server computer 116, or the like, of FIG. 1.

Network computers, such as, network computer 300 may include a processor 302 that may be in communication with a memory 304 via a bus 328. In some embodiments, processor 302 may be comprised of one or more hardware processors, or one or more processor cores. In some cases, one or more of the one or more processors may be specialized processors designed to perform one or more specialized actions, such as, those described herein. Network computer 300 also includes a power supply 330, network interface 332, audio interface 356, display 350, keyboard 352, input/output interface 338, processor-readable stationary storage device 334, and processor-readable removable storage device 336. Power supply 330 provides power to network computer 300.

Network interface 332 includes circuitry for coupling network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. Network interface 332 is sometimes known as a transceiver, transceiving device, or network interface card (NIC). Network computer 300 may optionally communicate with a base station (not shown), or directly with another computer.

Audio interface 356 is arranged to produce and receive audio signals such as the sound of a human voice. For example, audio interface 356 may be coupled to a speaker and microphone (not shown) to enable telecommunication with others or generate an audio acknowledgment for some action. A microphone in audio interface 356 can also be used for input to or control of network computer 300, for example, using voice recognition.

Display 350 may be a liquid crystal display (LCD), gas plasma, electronic ink, light emitting diode (LED), Organic LED (OLED) or any other type of light reflective or light transmissive display that can be used with a computer. In some embodiments, display 350 may be a handheld projector or pico projector capable of projecting an image on a wall or other object.

Network computer 300 may also comprise input/output interface 338 for communicating with external devices or computers not shown in FIG. 3. Input/output interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, input/output interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to network computer 300. Human interface components can be physically separate from network computer 300, allowing for remote input or output to network computer 300. For example, information routed as described here through human interface components such as display 350 or keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 358 to receive user input.

GPS transceiver 340 can determine the physical coordinates of network computer 300 on the surface of the Earth, which typically outputs a location as latitude and longitude values. GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 300 on the surface of the Earth. It is understood that under different conditions, GPS transceiver 340 can determine a physical location for network computer 300. In one or more embodiments, however, network computer 300 may, through other components, provide other information that may be employed to determine a physical location of the client computer, including for example, a Media Access Control (MAC) address, IP address, and the like.

In at least one of the various embodiments, applications, such as, operating system 306, skills engine 322, ingestion engine 324, other services 328, or the like, may be arranged to employ geo-location information to select one or more localization features, such as, time zones, languages, currencies, currency formatting, calendar formatting, or the like. Localization features may be used in user interfaces, dashboards, reports, as well as internal processes or databases. In at least one of the various embodiments, geo-location information used for selecting localization information may be provided by GPS 340. Also, in some embodiments, geolocation information may include information provided using one or more geolocation protocols over the networks, such as, wireless network 108 or network 111.

Memory 304 may include Random Access Memory (RAM), Read-Only Memory (ROM), or other types of memory. Memory 304 illustrates an example of computer-readable storage media (devices) for storage of information such as computer-readable instructions, data structures, program modules or other data. Memory 304 stores a basic input/output system (BIOS) 308 for controlling low-level operation of network computer 300. The memory also stores an operating system 306 for controlling the operation of network computer 300. It will be appreciated that this component may include a general-purpose operating system such as a version of UNIX, or Linux®, or a specialized operating system such as Microsoft Corporation's Windows® operating system, or the Apple Corporation's MacOS® operating system. The operating system may include, or interface with one or more virtual machine modules, such as, a Java virtual machine module that enables control of hardware components or operating system operations via Java application programs. Likewise, other runtime environments may be included.

Memory 304 may further include one or more data storage 310, which can be utilized by network computer 300 to store, among other things, applications 320 or other data. For example, data storage 310 may also be employed to store information that describes various capabilities of network computer 300. The information may then be provided to another device or computer based on any of a variety of methods, including being sent as part of a header during a communication, sent upon request, or the like. Data storage 310 may also be employed to store social networking information including address books, friend lists, aliases, user profile information, or the like. Data storage 310 may further include program code, data, algorithms, and the like, for use by a processor, such as processor 302 to execute and perform actions such as those actions described below. In one embodiment, at least some of data storage 310 might also be stored on another component of network computer 300, including, but not limited to, non-transitory media inside processor-readable removable storage device 336, processor-readable stationary storage device 334, or any other computer-readable storage device within network computer 300, or even external to network computer 300. Data storage 310 may include, for example, course information 312, course profiles 314, skills models 316, cognitive taxonomies 318, or the like.

Applications 320 may include computer executable instructions which, when executed by network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Applications 320 may include skills engine 322, ingestion engine 324, other services 328, or the like, that may be arranged to perform actions for embodiments described below. In one or more of the various embodiments, one or more of the applications may be implemented as modules or components of another application. Further, in one or more of the various embodiments, applications may be implemented as operating system extensions, modules, plugins, or the like.

Furthermore, in one or more of the various embodiments, skills engine 322, ingestion engine 324, other services 328, or the like, may be operative in a cloud-based computing environment. In one or more of the various embodiments, these applications, and others, that comprise the management platform may be executing within virtual machines or virtual servers that may be managed in a cloud-based based computing environment. In one or more of the various embodiments, in this context the applications may flow from one physical network computer within the cloud-based environment to another depending on performance and scaling considerations automatically managed by the cloud computing environment. Likewise, in one or more of the various embodiments, virtual machines or virtual servers dedicated to skills engine 322, ingestion engine 324, other services 328, or the like, may be provisioned and de-commissioned automatically.

Also, in one or more of the various embodiments, skills engine 322, ingestion engine 324, other services 328, or the like, may be located in virtual servers running in a cloud-based computing environment rather than being tied to one or more specific physical network computers.

Further, network computer 300 may also comprise hardware security module (HSM) 360 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 360 may be a stand-alone network computer, in other cases, HSM 360 may be arranged as a hardware card that may be installed in a network computer.

Additionally, in one or more embodiments (not shown in the figures), network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include one or more hardware microcontrollers instead of a CPU. In one or more embodiments, the one or more microcontrollers may directly execute their own embedded logic to perform actions and access their own internal memory and their own external Input and Output Interfaces (e.g., hardware pins or wireless transceivers) to perform actions, such as System On a Chip (SOC), or the like.

### Illustrative Logical System Architecture

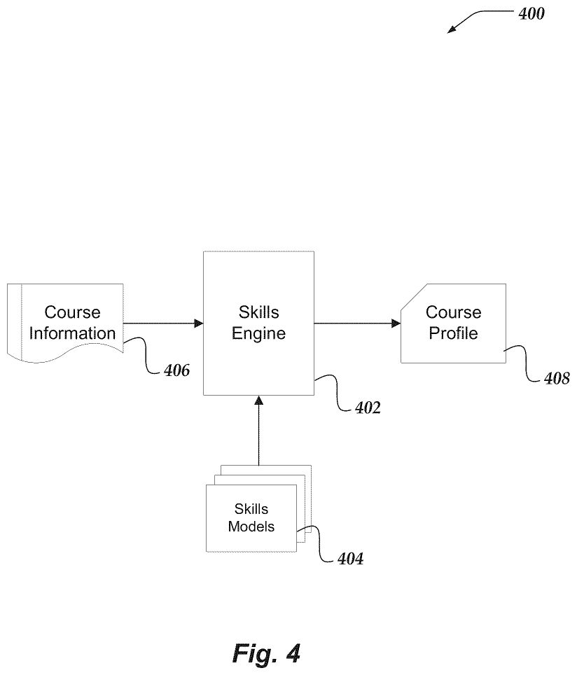

FIG. 4 illustrates a logical architecture of system 400 for determining interpersonal or behavioral skills based on course information in course offerings in accordance with one or more of the various embodiments.

In some cases, it may be advantageous for educational institutions to determine the skills and skill proficiency that may be learned or taught by courses offered by the institutions. Also, it may be advantageous for educational organizations, government agencies, or the like, to compare different courses, skills, skill proficiency, or the like, across educational organizations. Likewise, in some cases, it may be advantageous for students or others to evaluate courses, courses of study, institutions, or the like, based on the skills and skill proficiencies that may be learned from particular courses.

Accordingly, in some embodiments, skills engines may be arranged to provide a normalized/standard representation of the skills and skill proficiencies of courses taught by institutions. Conventionally, institutions may provide lists or summaries or skill and proficiencies for various courses. However, often such lists or summaries may comprise non-standard skill definitions, arbitrary skill proficiencies, or the like. Likewise, there may be mismatches between skill summaries and the actual teaching/learning that may occur in specific courses.

In some cases, students or others may employ course information such as syllabuses, course catalog descriptions, or the like, to evaluate skill or skill proficiencies that may be learned from various courses. However, in some cases, determining skill and skill proficiencies from course information may be disadvantageous for one or more reasons, including lack of standardization within or across institutions, mismatches in the course information and the actual course, or the like.

While, in some cases, learners or employers may be enabled to determine particular skills or acumen provided by various courses based on a review of conventional course information. Often this course information may provide detailed descriptions of various learning objectives for a course. However, often the learning objectives narrowly describe the subjects being taught as well as specific activities student may perform to demonstrate their learned skills. Also, conventional course information typically is focused on describing tangible skills or tangible activities that may be learned or performed.

Also, in many cases, conventional course information may omit describing important soft-skills that may be learned or acquired from a course. Accordingly, learners or employers may be unable to discern which soft-skills may be associated with a given course. However, in some cases, the natural language included in narratives associated with learning objectives may be evaluated to identify if a course may convey soft-skills.

Accordingly, in some embodiments, systems, such as, system 400 may include skills engines that may be arranged to infer the soft skills that may be learned from course.

In one or more of the various embodiments, system 400 may be arranged to include skills engine 402, soft skills models 404, course information 406, course profile 408, or the like.

In one or more of the various embodiments, skills engines, such as, skills engine 402 may be arranged to determine one or more soft-skills that may be acquired from courses based on the course information associated with a course. In some embodiments, course information may include information, such as, course syllabuses, course catalogs, course descriptions, or the like. In some embodiments, course information may be collected from one or more sources and stored in a course information data store (not shown). In some embodiments, course information may be considered information generally available to the public (e.g., learners or employers) that describe one or more learning objectives of a course. In many cases, learning objectives may be described with a text-based narrative that describe the learning activities, subject matter, or the like. Often a course may include more than one learning objective.

In one or more of the various embodiments, skills engines may be arranged to employ one or more skills models, such as, skills models 404, that employ natural language processing, machine learning, various heuristics, or the like, to determine soft skills based on the learning objectives for a course.

In some embodiments, skills engines may be arranged to determine the soft-skills that may be inferred to be learned from those learning objectives. Accordingly, in some embodiments, skills engines may be arranged to update course profiles to reflect the soft-skills that may be learned or acquired from courses taken. Thus, in some embodiments, learners and employers may be provided a better understanding of how a particular course may satisfy their goals.

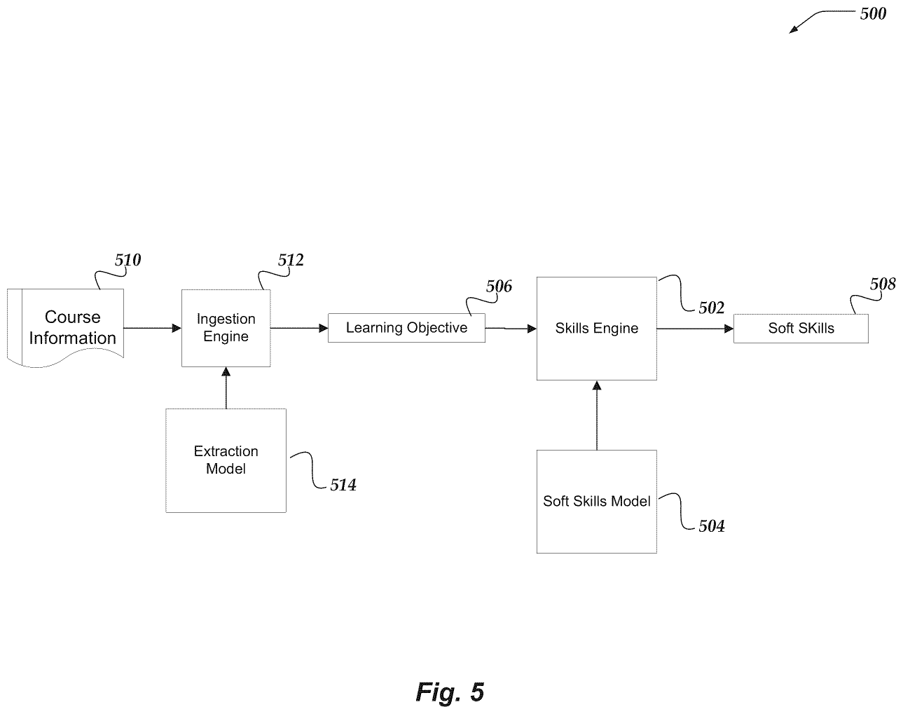

FIG. 5 illustrates a logical representation of system 500 for determining interpersonal or behavioral skills based on course information in accordance with one or more of the various embodiments. As described above, in some embodiments, skills engines, such as, skills engine 502 may be provided learning objectives, such as, learning objective 506, from course information 510. Accordingly, in some embodiments, skills engine 502 may employ a skills model, such as, skills model 504 to infer which soft-skills, such as, soft-skills 508 may be associated with learning objective 506.

In one or more of the various embodiments, learning objectives, such as, learning objective 506 may be determined from course information, such as, course information 510. In some embodiments, one or more services, such as, ingestion engine 512 may be arranged to employ machine-learning, NLP, heuristics, or the like, to identify the learning objectives from course information. For example, course syllabuses often include one or more sections dedicated to outlining the learning objectives for a course. In some cases, educational institutions may employ a consistent format or structured format for their course information that enable ingestion engines to extract learning objectives.

Also, in some embodiments, learning objectives may be a chunk of text that provides description of activities, projects, subject matter, or the like in a natural language narrative that ingestion engines may be trained or configured to recognize or extract. Accordingly, in some embodiments, ingestion engines may be arranged to employ extraction models, such as, extraction model 514 for determining learning objectives or learning objective narratives from course information. In some embodiments, ingestion engines or predictive learner platforms may be arranged to determine extraction models based on configuration information. Thus, in some embodiments, different extraction models may be provided for different organizations to account for local requirements or local circumstances.

In some embodiments, skills engines may be arranged to receive learning objectives in text form and employ one or more skills models to infer the soft-skills that may be conferred by the learning objective, if any.

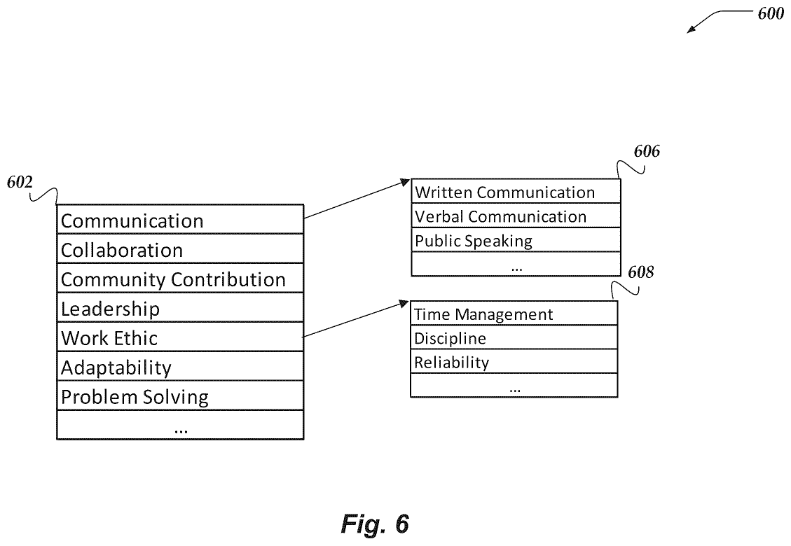

FIG. 6 illustrates a logical schematic of soft-skills 700 for determining interpersonal or behavioral skills based on course information in accordance with one or more of the various embodiments.

In some embodiments, skills engines may be arranged to infer one or more soft-skills from learning objectives. Soft-skills may be a class of generally applicable skills that may be learned from various courses of differing subjects. In some cases, acquiring soft-skills may be the indirect result of the actions or activities associated with learning one or more hard-skills. In this example, table 602 represents a collection of soft-skills. In some cases, one or more soft skills may be considered major skills that may be associated with one or more other soft-skills, such as, collection 606 or collection 608.

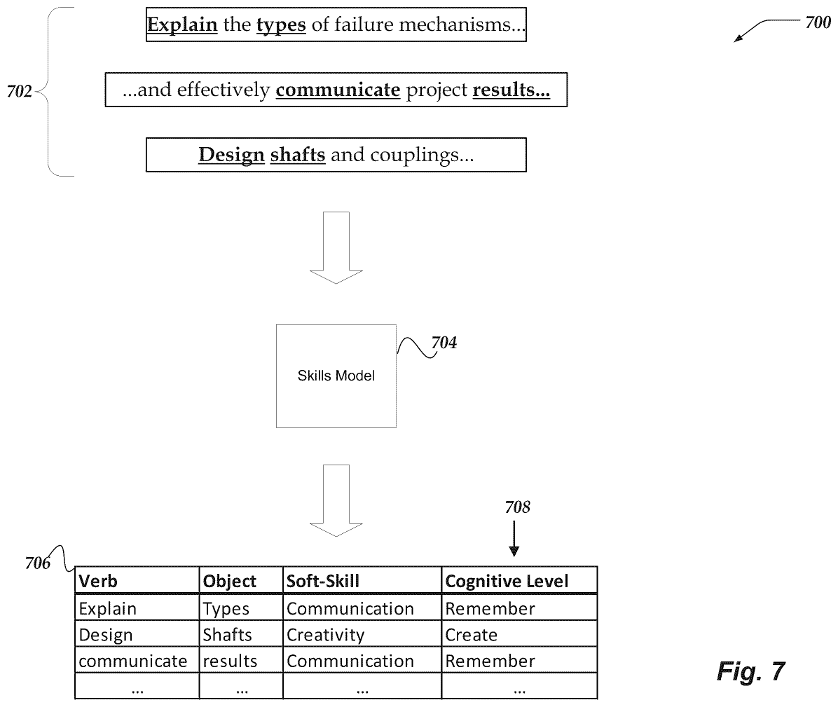

FIG. 7 illustrates a logical schematic of system 700 for determining interpersonal or behavioral skills based on course information in accordance with one or more of the various embodiments. As described above, skills engines may be arranged to support more than one skills model. Thus, in some embodiments, skills engines may be arranged to employ new or improved or skills models if they may be discovered.

In some embodiments, skills engines may be arranged to determine learning objective narratives that comprise text. Accordingly, in some embodiments, skills models may be arranged to include one or more of heuristics, machine-learning classifiers, NLP, or the like, for determining soft-skills, cognitive levels, or the like.

In this example, for some embodiments, skills model 704 may be arranged to determine one or more soft-skills that may be associated with a learning objective based on one or more provided learning objective narratives. Accordingly, in some embodiments, skills engines may be arranged to provide one or more learning objective narratives, such as, learning objective narratives 702 to a skills model, such as skills model 704.

In some embodiments, skills models, such as, skills model 704 may be arranged to employ NLP to determine verbs and objects from the learning objective narrative. Accordingly, in some embodiments, the verb and object tuples may be mapped to one or more soft-skills as illustrated by table 706. In some embodiments, skills models may employ one set of heuristics, machine-learning classifiers, or NLP to determine the soft-skills. Further, in some embodiments, a dedicated training engine (not shown) or skills engine, such as, skills engine 322 may be arranged to train one or more machine learning based skills models. In one or more of the various embodiments, the particular actions performed for training skills models may depend on type of model (e.g., linear regression, deep learning, deep neural networks, decision trees, ensembles of two or more smaller models, or the like). Also in some embodiments, the type of training may be dependent on the application the skills models may be targeted towards. For example, in one or more of the various embodiments, for some classification problems one ML model type may be preferred over another. Accordingly, in some embodiments, skills engines may be arranged to collect feedback from users or administrators that may be used to score or rate the performance of various skills models. Accordingly, in some embodiments, these innovations anticipate that skills models may be changed or improved often or continuously based on user/administrator feedback, advancements in ML/prediction models, changes to available training data, or the like.

Also, in one or more of the various embodiments, skills models may be arranged to infer cognitive skills or cognitive levels as indicated by column 706.

In one or more of the various embodiments, skills engines may be arranged to provide user interfaces that enable learners, employers, or other users to evaluate how well a skills model performed. Accordingly, in some embodiments, organizations may collect feedback regarding the performance of skills models. Accordingly, in some embodiments, if the feedback for a skills model results in a quality score that falls below a threshold value, skills engines may be arranged to automatically withdraw that skills model from production.

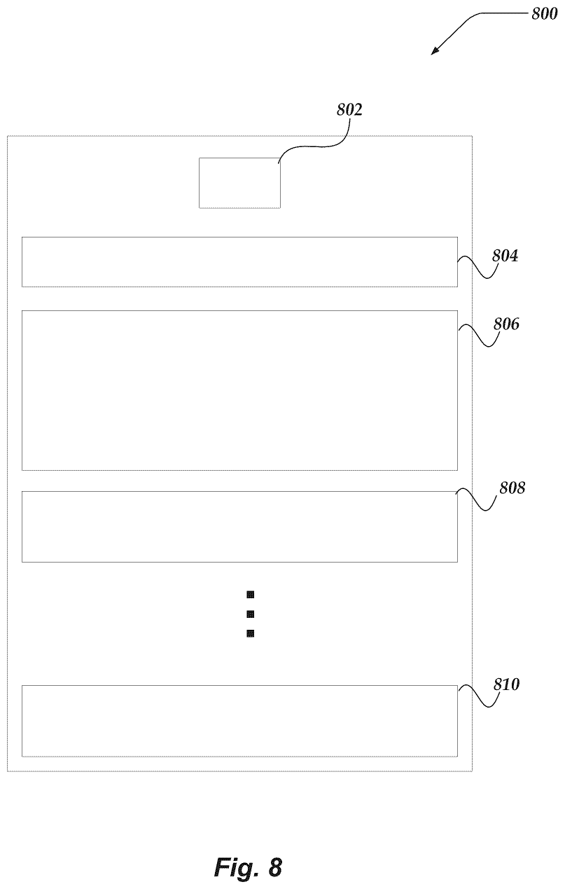

FIG. 8 illustrates a logical schematic of syllabus 800 for determining interpersonal or behavioral skills based on course information in accordance with one or more of the various embodiments. In some cases, course information may be provided by syllabuses, such as syllabus 800. Often syllabuses come in a variety of formats or arrangements. However, in most cases, syllabuses will include a collection of learning objectives for a given course. In some cases, the learning objectives are explicitly provided in a list, grouped into one or more sections, or the like. Alternatively, in some cases, learning objectives may be embedded in multiple sections of a syllabus. In this example, syllabus 800 includes section 802, section 804, section 806, section 808, section 810, or the like. Accordingly, in this example, for some embodiments, one or more learning objectives may be included in one or more of these sections.

In some embodiments, ingestion engines may be arranged to extract learning objectives or learning objective narratives from course information, including syllabus 800, or the like. Accordingly, in some embodiments, skills engines may be provided learning objective narratives from differently formatted or arranged syllabuses.

### Generalized Operations

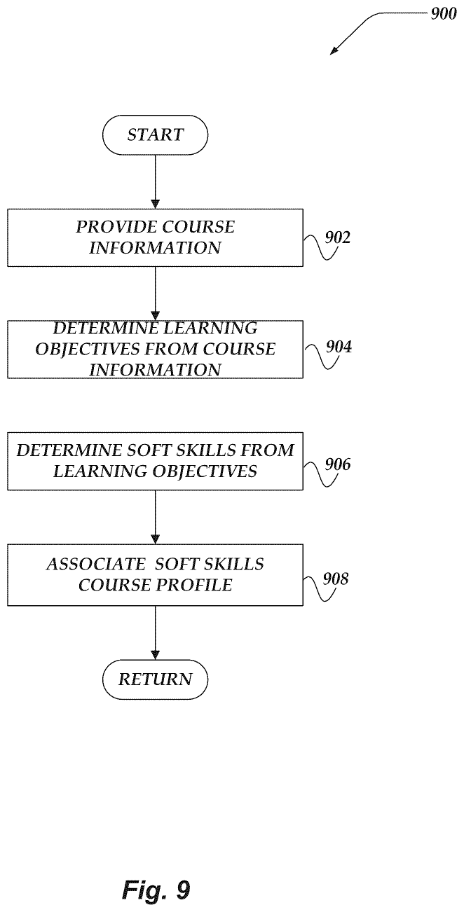

FIGS. 9-12 represent generalized operations for determining interpersonal or behavioral skills based on course information in accordance with one or more of the various embodiments. In one or more of the various embodiments, processes 900, 1000, 1100, and 1200 described in conjunction with FIGS. 9-12 may be implemented by or executed by one or more processors on a single network computer, such as network computer 300 of FIG. 3. In other embodiments, these processes, or portions thereof, may be implemented by or executed on a plurality of network computers, such as network computer 300 of FIG. 3. In yet other embodiments, these processes, or portions thereof, may be implemented by or executed on one or more virtualized computers, such as those in a cloud-based environment. However, embodiments are not so limited and various combinations of network computers, client computers, or the like may be utilized. Further, in one or more of the various embodiments, the processes described in conjunction with FIGS. 9-12 may perform actions for interpersonal or behavioral skills based on course information in accordance with at least one of the various embodiments or architectures such as those described in conjunction with FIGS. 4-8. Further, in one or more of the various embodiments, some or all of the actions performed by processes 900, 1000, 1100, and 1200 may be executed in part by skills engine 322, ingestion engine 324, or the like.

FIG. 9 illustrates an overview flowchart for process 900 for determining interpersonal or behavioral skills based on course information in accordance with one or more of the various embodiments. After a start block, at block 902, in one or more of the various embodiments, course information for a course may be provided. As described above, predictive learner platform may include or employ ingestion engines that may consume course information, such as, syllabuses, course catalog descriptions, or the like.

At block 904, in one or more of the various embodiments, ingestion engines or skills engines may be arranged to determine one or more learning objectives from the course information. As described above, in some embodiments, ingestion engines or skills engines may be arranged to employ one or more extraction models that may include one or more heuristics, machine-learning classifiers, NLP, or the like, that may be employed to extract learning objectives and learning objective narratives from the course information. In some embodiments, one or more extraction models may be developed for different institutions or different types of course information.

In one or more of the various embodiments, learning objectives may include narratives that describe in human readable text the subjects the learning objective may be directed toward.

At block 906, in one or more of the various embodiments, skills engines may be arranged to determine one or more soft skills based on the learning objectives or other course information that may be included in course syllabuses, or the like. In some embodiments, skills engines may be arranged to provide learning objective narratives to one or more skills models that may be trained or tuned to infer soft-skills from course information.

At block 908, in one or more of the various embodiments, skills engines may be arranged to be associate one or more determined soft-skills with the course profile for the course. Accordingly, in some embodiments, predictive learner platforms may be arranged to employ these enhanced course profiles to match learners with employment opportunities. Likewise, in some embodiments, updated course profiles may be employed to determine learning pathways for students seeking particular career or employment opportunity.

Next, in one or more of the various embodiments, control may be returned to a calling process.

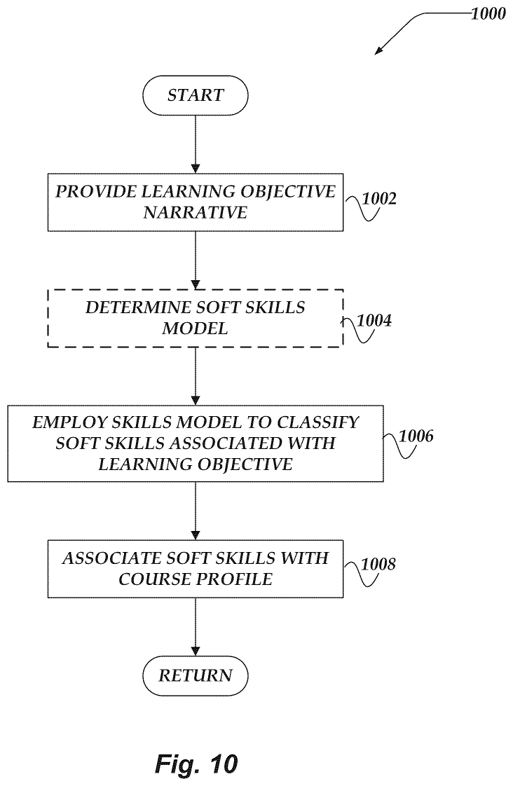

FIG. 10 illustrates a flowchart for process 1000 for determining interpersonal or behavioral skills based on course information in accordance with one or more of the various embodiments. After a start block, at block 1002, in one or more of the various embodiments, a learning objective narrative may be provided to a skills engine. As described above, in some embodiments, learning objective narratives may be extracted from course information.

At block 1004, in one or more of the various embodiments, optionally, skills engines may be arranged to determine a soft skills model. In some embodiments, skills engines may be configured to have multiple skills models. In some embodiments, one or more skills models may be trained for inferring soft-skills from learning objectives. In some cases, different skills models may be tuned for different types of skills. Also, in some embodiments, one or more skills models may be tuned for different organizations, education institutions, career areas, or the like. For example, in some embodiments, educational institution A may employ formats or standards for course information that may be significantly different than educational institution B where it may be advantageous to have separately tuned/trained skills models. Accordingly, in some embodiments, skills engines may be arranged to employ rules, instructions, or the like, that associate particular skills models with particular education institutions.

Note, this block is indicated as being optional because in some cases for some embodiments skills engines may be configured to use a default skills model or otherwise have determined the skills model previously.

At block 1006, in one or more of the various embodiments, skills engines may be arranged to determine one or more soft-skills based on the learning objective.

In one or more of the various embodiments, one or more skills models may be arranged to compare the similarity of learning objective narratives with narratives, word sets, or the like, that may be associated with one or more soft skills. For example, in some embodiments, portions of learning objective narratives may be vectorized to enable skills models that support cosine similarity evaluation, or the like. Likewise, in some embodiments, skills models may be configured to perform NLP such as word/phrase frequency analysis, parts of speech comparisons, or the like, to determine similarity scores for learning objectives. In some embodiments, skills models may combine two or more NLP methods for correlating one or more soft skills with learning objectives.

At block 1008, in one or more of the various embodiments, skills engines may be arranged to associate the one or more determined soft-skills with the course profile of the course.

Next, in one or more of the various embodiments, control may be returned to a calling process.

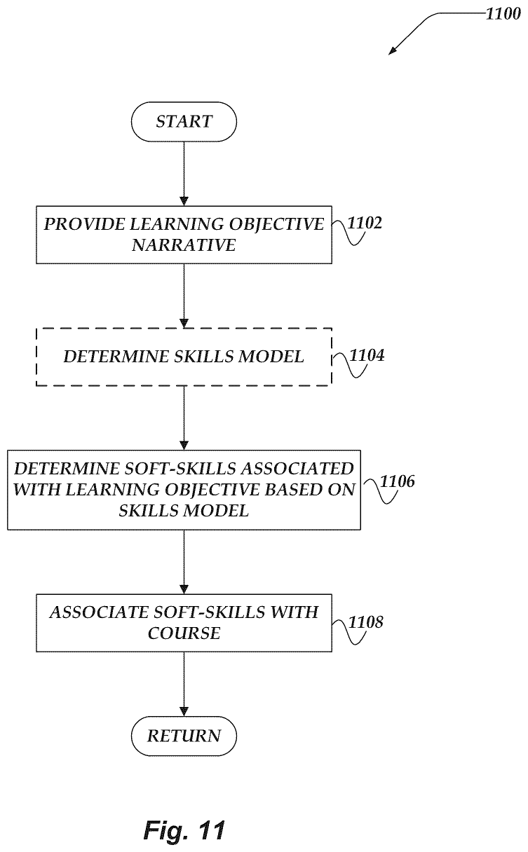

FIG. 11 illustrates a flowchart for process 1100 for determining interpersonal or behavioral skills based on course information in accordance with one or more of the various embodiments. After a start block, at block 1102, in one or more of the various embodiments, a learning objective narrative may be provided to a skills engine. As described above, in some embodiments, skills engines may provide learning objectives narratives that may be determined from course information.

At block 1104, in one or more of the various embodiments, optionally skills engines may be arranged to determine a skills model for evaluating the learning objective narrative.

In some embodiments, skills engines may be configured with multiple skills models available. In some embodiments, one or more skills models may be trained for inferring soft-skills. In some cases, different skills models may be tuned for different classes of soft skills. Also, in some embodiments, one or more skills models may be tuned for different organizations, education institutions, career areas, or the like. For example, in some embodiments, educational institution A may employ formats or standards for course information that may be significantly different than educational institution B where it may be advantageous to have separately tuned skills models. Accordingly, in some embodiments, skills engines may be arranged to employ rules, instructions, or the like, that associate particular skills models with particular education institutions.

Here, in some embodiments, skills engines may be arranged to determine a skills model that may be trained or tuned for determining soft-skills directly from learning objective narratives.

Note, this block is indicated as being optional because in some cases for some embodiments skills engines may be configured to use a default skills model or otherwise have determined the skills model previously.

At block 1106, in one or more of the various embodiments, skills engines may be arranged to determine one or more soft-skills associated with the learning objective based on a skills model. In one or more of the various embodiments, skills engines may be arranged to employ the determined skills models to infer one or more soft-skills from the learning objective narrative. Accordingly, in some embodiments, skills engines may execute one or more NLP actions as per the skills model to determine one or more soft-skills that may be associated with the learning objective.

As described herein, in one or more of the various embodiments, skills models may be arranged to base soft-skills inferences on NLP matches of portions of the learning objective narrative with a soft-skills taxonomy that associates various words or phrases with particular soft-skills.

At block 1108, in one or more of the various embodiments, skills engines may be arranged to associate the one or more soft-skills with the course profile. In one or more of the various embodiments, the one or more inferred soft-skills may be included in course profile of the course associated with the learning objective being evaluated.

Next, in one or more of the various embodiments, control may be returned to a calling process.

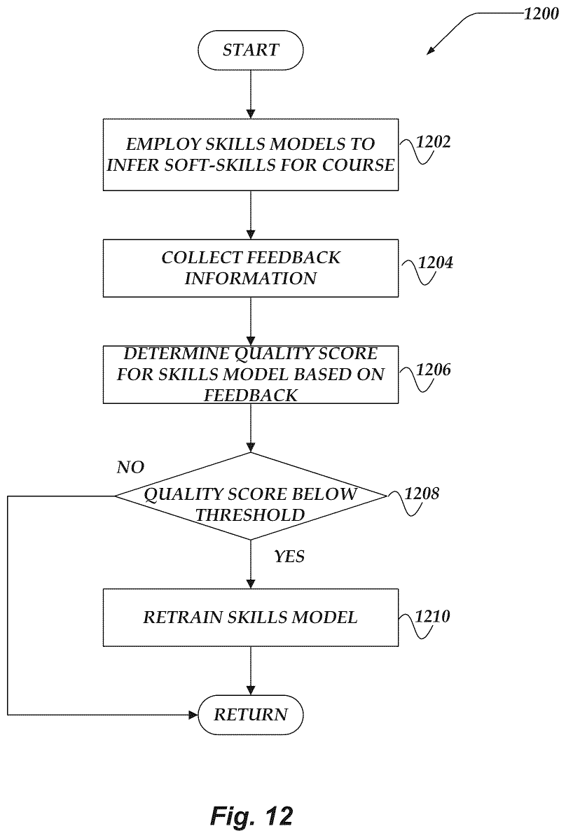

FIG. 12 illustrates a flowchart for process 1200 for determining interpersonal or behavioral skills based on course information in accordance with one or more of the various embodiments. After a start block, at block 1202, in one or more of the various embodiments, skills engines may be arranged to employ skills models to infer one or more soft-skills, or the like, from course information. In some embodiments, course profiles may be updated based on the inferred soft-skills, or the like. Accordingly, in some embodiments, course profile information may be employed to update learner profiles based on the soft-skills, or the like, that may be learned from various courses.

At block 1204, in one or more of the various embodiments, skills engines may be arranged to collect feedback information. In one or more of the various embodiments, skills engines, predictive learner platforms, or the like, may be arranged to provide various user interfaces that enable users, learners, employers, administrators, or the like, to provide direct or indirect regarding the veracity of the inferences. Accordingly, in some embodiments, skills engines may be arranged to collect one or more quality metrics associated with particular skills models. For example, in some embodiments, organizations may employ one or more users to evaluate a sample of inferences made by skills models. Also, for example, in some embodiments, learners or employers may be provided user interfaces to collect direct feedback related to learner-role matches, or the like. Also, in some embodiments, over time predictive learner platforms may be enabled to track the employment history of matched learners. Thus, for example, predictive learner platforms may be arranged to track the duration of employment of matched learners. Likewise, in some embodiments, predictive learner platforms may be arranged to monitor how matched learners fail to convert into employees of matched employers.

At block 1206, in one or more of the various embodiments, skills engines may be arranged to determine quality score for skills model based on collected feedback information. In some embodiments, predictive learner platforms may be arranged to employ one or more rules, instructions, formulas, or the like, provided via configuration information to evaluate the one or more metrics collected from feedback information. Accordingly, in some embodiments, one or more metric values may be combined into one or more quality scores that may be employed to determine if skills models may be provided quality inferences.

In one or more of the various embodiments, skills engines may be arranged to compare the performance of skills models with one or more reference models. Accordingly, in one or more of the various embodiments, skills engines may be arranged to provide test information from a corpus of course information for one or more exemplar courses. Thus, in some embodiments, skills engines may be arranged to automatically generate quality scores for the skills models.

Further, in some embodiments, skills engines may be arranged to generate quality scores for skills models based on a combination of quality metrics or machine learning evaluation using reference models. In some embodiments, different types of quality metrics, reference models, or the like, may be employed for different types of courses, different cognitive levels, different soft skills, or the like. Thus, in some embodiments, skills engines may be arranged to determine particular quality metrics, reference models, quality determinations, or the like, based on configuration information to account for local circumstances or local requirements.

At decision block 1208, in one or more of the various embodiments, if one or more quality scores may be below a threshold value, control may flow to block 1210; otherwise, control may be returned to a calling process.

In one or more of the various embodiments, quality scores of skills models may fall overtime if the narratives associated with learning objectives change overtime. Also, in some embodiments, as predictive learner platforms may be applied to new organizations, new subject matter, or the like, inference veracity of skills models may decline. Similarly, in some embodiments, the meaning or application of one or more terms used in learning objectives may shift overtime which may cause skills model veracity to decline.

Accordingly, in some embodiments, if a skills model may be associated with low quality scores, skills engines or predictive learner platforms may be arranged to remove such skills models from production.

At block 1210, in one or more of the various embodiments, the low quality skills model may be retrained. In some embodiments, predictive learner platforms may be arranged to automatically provide skills models to automatic or machine assisted training systems to retrain the low quality skills models. For example, in some embodiments, skills engines may retrain low-quality skills models using one or more machine learning reference models and a corpus of training data course information.

Alternatively, in some embodiments, predictive learner platforms may be arranged to discard low quality models in lieu of new skills models that may perform at acceptable levels.

Next, in one or more of the various embodiments, control may be returned to a calling process.

It will be understood that each block in each flowchart illustration, and combinations of blocks in each flowchart illustration, can be implemented by computer program instructions. These program instructions may be provided to a processor to produce a machine, such that the instructions, which execute on the processor, create means for implementing the actions specified in each flowchart block or blocks. The computer program instructions may be executed by a processor to cause a series of operational steps to be performed by the processor to produce a computer-implemented process such that the instructions, which execute on the processor, provide steps for implementing the actions specified in each flowchart block or blocks. The computer program instructions may also cause at least some of the operational steps shown in the blocks of each flowchart to be performed in parallel. Moreover, some of the steps may also be performed across more than one processor, such as might arise in a multi-processor computer system. In addition, one or more blocks or combinations of blocks in each flowchart illustration may also be performed concurrently with other blocks or combinations of blocks, or even in a different sequence than illustrated without departing from the scope or spirit of the invention.

Accordingly, each block in each flowchart illustration supports combinations of means for performing the specified actions, combinations of steps for performing the specified actions and program instruction means for performing the specified actions. It will also be understood that each block in each flowchart illustration, and combinations of blocks in each flowchart illustration, can be implemented by special purpose hardware-based systems, which perform the specified actions or steps, or combinations of special purpose hardware and computer instructions. The foregoing example should not be construed as limiting or exhaustive, but rather, an illustrative use case to show an implementation of at least one of the various embodiments of the invention.

Further, in one or more embodiments (not shown in the figures), the logic in the illustrative flowcharts may be executed using an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. In one or more embodiments, a microcontroller may be arranged to directly execute its own embedded logic to perform actions and access its own internal memory and its own external Input and Output Interfaces (e.g., hardware pins or wireless transceivers) to perform actions, such as System On a Chip (SOC), or the like.

1. A method of managing a data platform over a network, using one or more network computers to execute the method by causing performance of actions, comprising:
determining one or more learning objectives from course information associated with a course, wherein the course information is employed to describe one or more tangible skills to be learned and one or more tangible activities performed by a person completing the course, and wherein natural language processing of the one or more learning objectives and a plurality of different syllabuses for the course is employed to generate one or more learning objective narratives, wherein a skills model is trained with the one or more learning objective narratives and the one or more tangible skills;
employing the trained skills model and the one or more learning objectives to infer one or more soft skills to be learned by the person taking the course, wherein the one or more soft skills include communication, collaboration, leadership, work ethic, adaptability, or problem solving;
employing natural language processing of the one or more learning objective narratives and the one or more tangible skills to determine one or more verbs and objects that map to the one or more soft skills, wherein the one or more mapped soft skills are employed by the trained skills model to infer one or more cognitive levels for the person including remember or creativity, wherein the one or more mapped soft skills and the one or more cognitive levels are used to update a course profile that corresponds to the course; and
employing a quality score corresponding to the skills model that is less than a threshold value and user feedback provided in one or more user interfaces to automatically retrain the skills model, wherein retraining of the skills model employs one or more machine learning processes for portions of one or more reference models, administrator feedback and training data course information.

2. The method of claim 1, wherein determining the one or more learning objectives, further comprises:
ingesting one or more of a course syllabus or a course catalog associated with the course;
providing contents of the course information to an extraction model to determine the one or more learning objectives or the one or more learning objective narratives; and
providing the one or more learning objectives or the one or more learning objective narratives to a skills engine.

3. The method of claim 1, wherein employing the skills model to determine one or more soft skills, further comprises:
providing a soft skill taxonomy associated with one or more words or one or more phrases with one or more soft skills, wherein soft skills include one or more of creativity, communication, collaboration, community contribution, leadership, work ethic, adaptability, or problem solving; and
employing one or more natural language processing actions declared in the skills model to determine the one or more soft skills based on matching the one or more learning objective narratives with the soft skill taxonomy.

4. The method of claim 1, further comprising:
determining the skills model based on one or more characteristics of the course information, wherein the one or more characteristics include one or more of a course type, a course subject matter, a syllabus format, or a syllabus format.

5. The method of claim 1, further comprising:
determining the quality score based on one or more quality metrics associated with the skills model, wherein the one or more quality metrics are collected from one or more of a user-interface that provides a user satisfaction or one or more measured user interactions with the course profile or one or more learner profiles.

6. The method of claim 1, further comprising:
employing other course information associated with one or more courses to generate one or more skills models based on one or more of machine learning, experimental observation, or configurable heuristics.

7. A processor readable non-transitory storage media that includes instructions for managing a data platform over a network, wherein execution of the instructions, by one or more processors, are configured to cause performance of actions, comprising:
determining one or more learning objectives from course information associated with a course, wherein the course information is employed to describe one or more tangible skills to be learned and one or more tangible activities performed by a person completing the course, and wherein natural language processing of the one or more learning objectives and a plurality of different syllabuses for the course is employed to generate one or more learning objective narrative, wherein a skills model is trained with the one or more learning objective narratives and the one or more tangible skills;
employing the trained skills model and the one or more learning objectives to infer one or more soft skills to be learned by the person taking the course, wherein the one or more soft skills include communication, collaboration, leadership, work ethic, adaptability, or problem solving;
employing natural language processing of the one or more learning objective narratives and the one or more tangible skills to determine one or more verbs and objects that map to the one or more soft skills, wherein the one or more mapped soft skills are employed by the trained skills model to infer one or more cognitive levels for the person including remember or creativity, wherein the one or more mapped soft skills and the one or more cognitive levels are used to update a course profile that corresponds to the course; and
employing a quality score corresponding to the skills model that is less than a threshold value and user feedback provided in one or more user interfaces to automatically retrain the skills model, wherein retraining of the skills model employs one or more machine learning processes for portions of one or more reference models, administrator feedback and training data course information.

8. The media of claim 7, wherein determining the one or more learning objectives, further comprises:
ingesting one or more of a course syllabus or a course catalog associated with the course;
providing contents of the course information to an extraction model to determine the one or more learning objectives or the one or more learning objective narratives; and
providing the one or more learning objectives or the one or more learning objective narratives to a skills engine.

9. The media of claim 7, wherein employing the skills model to determine one or more soft skills, further comprises:
providing a soft skill taxonomy associated with one or more words or one or more phrases with one or more soft skills, wherein soft skills include one or more of creativity, communication, collaboration, community contribution, leadership, work ethic, adaptability, or problem solving; and
employing one or more natural language processing actions declared in the skills model to determine the one or more soft skills based on matching the one or more learning objective narratives with the soft skill taxonomy.

10. The media of claim 7, further comprising:
determining the skills model based on one or more characteristics of the course information, wherein the one or more characteristics include one or more of a course type, a course subject matter, a syllabus format, or a syllabus content.

11. The media of claim 7, further comprising:
determining the quality score based on one or more quality metrics associated with the skills model, wherein the one or more quality metrics are collected from one or more of a user-interface that provides a user satisfaction or one or more measured user interactions with the course profile or one or more learner profiles.

12. The media of claim 7, further comprising:
employing other course information associated with one or more courses to generate one or more skills models based on one or more of machine learning, experimental observation, or configurable heuristics.

13. A system for managing a data platform, comprising:
a network computer, comprising:
a memory that stores at least instructions; and
one or more processors that execute instructions that are configured to cause performance of actions, including:
determining one or more learning objectives from course information associated with a course, wherein the course information is employed to describe one or more tangible skills to be learned and one or more tangible activities performed by a person completing the course, and wherein natural language processing of the one or more learning objectives and a plurality of different syllabuses for the course is employed to generate one or more learning objective narratives, wherein a skills model is trained with the one or more learning objective narratives and the one or more tangible skills;
employing the trained skills model and the one or more learning objectives to infer one or more soft skills to be learned by the person taking the course, wherein the one or more soft skills include communication, collaboration, leadership, work ethic, adaptability, or problem solving;
employing natural language processing of the one or more learning objective narratives and the one or more tangible skills to determine one or more verbs and objects that map to the one or more soft skills, wherein the one or more mapped soft skills are employed by the trained skills model to infer one or more cognitive levels for the person including remember or creativity, wherein the one or more mapped soft skills and the one or more cognitive levels are used to update a course profile that corresponds to the course; and
employing a quality score corresponding to the skills model that is less than a threshold value and user feedback provided in one or more user interfaces to automatically retrain the skills model, wherein retraining of the skills model employs one or more machine learning processes for portions of one or more reference models, administrator feedback and training data course information; and
a client computer, comprising:
a memory that stores at least instructions; and
one or more processors that execute instructions that perform actions, including:
displaying one or more portions of the course profile on a hardware display.

14. The system of claim 13, wherein determining the one or more learning objectives, further comprises:
ingesting one or more of a course syllabus or a course catalog associated with the course;
providing contents of the course information to an extraction model to determine the one or more learning objectives or the one or more learning objective narratives; and
providing the one or more learning objectives or the one or more learning objective narratives to a skills engine.

15. The system of claim 13, wherein employing the skills model to determine one or more soft skills, further comprises:
providing a soft skill taxonomy associated with one or more words or one or more phrases with one or more soft skills, wherein soft skills include one or more of creativity, communication, collaboration, community contribution, leadership, work ethic, adaptability, or problem solving; and
employing one or more natural language processing actions declared in the skills model to determine the one or more soft skills based on matching the one or more learning objective narratives with the soft skill taxonomy.

16. The system of claim 13, wherein the one or more network computer processors execute instructions that perform actions, further comprising:
determining the skills model based on one or more characteristics of the course information, wherein the one or more characteristics include one or more of a course type, a course subject matter, a syllabus format, or a syllabus content.

17. The system of claim 13, wherein the one or more network computer processors execute instructions that perform actions, further comprising:
determining the quality score based on one or more quality metrics associated with the skills model, wherein the one or more quality metrics are collected from one or more of a user-interface that provides a user satisfaction or one or more measured user interactions with the course profile or one or more learner profiles.

18. The system of claim 13, wherein the one or more network computer processors execute instructions that perform actions, further comprising:
employing other course information associated with one or more courses to generate one or more skills models based on one or more of machine learning, experimental observation, or configurable heuristics.

19. A network computer for managing a data platform over a network, comprising:
a memory that stores at least instructions; and
one or more processors that execute instructions that are configured to cause performance of actions, including:
determining one or more learning objectives from course information associated with a course, wherein the course information is employed to describe one or more tangible skills to be learned and one or more tangible activities performed by a person completing the course, and wherein natural language processing of the one or more learning objectives and a plurality of different syllabuses for the course is employed to generate one or more learning objective narratives, wherein a skills model is trained with the one or more learning objective narratives and the one or more tangible skills;
employing the trained skills model and the one or more learning objectives to infer one or more soft skills to be learned by the person taking the course, wherein the one or more soft skills include communication, collaboration, leadership, work ethic, adaptability, or problem solving;
employing natural language processing of the one or more learning objective narratives and the one or more tangible skills to determine one or more verbs and objects that map to the one or more soft skills, wherein the one or more mapped soft skills are employed by the trained skills model to infer one or more cognitive levels for the person including remember or creativity, wherein the one or more mapped soft skills and the one or more cognitive levels are used to update a course profile that corresponds to the course; and
employing a quality score corresponding to the skills model that is less than a threshold value and user feedback provided in one or more user interfaces to automatically retrain the skills model, wherein retraining of the skills model employs one or more machine learning processes for portions of one or more reference models, administrator feedback and training data course information.

20. The network computer of claim 19, wherein determining the one or more learning objectives, further comprises:
ingesting one or more of a course syllabus or a course catalog associated with the course;
providing contents of the course information to an extraction model to determine the one or more learning objectives or the one or more learning objective narratives; and
providing the one or more learning objectives or the one or more learning objective narratives to a skills engine.

21. The network computer of claim 19, wherein employing the skills model to determine one or more soft skills, further comprises:
providing a soft skill taxonomy associated with one or more words or one or more phrases with one or more soft skills, wherein soft skills include one or more of creativity, communication, collaboration, community contribution, leadership, work ethic, adaptability, or problem solving; and
employing one or more natural language processing actions declared in the skills model to determine the one or more soft skills based on matching the one or more learning objective narratives with the soft skill taxonomy.

22. The network computer of claim 19, wherein the one or more processors execute instructions that perform actions, further comprising:
determining the skills model based on one or more characteristics of the course information, wherein the one or more characteristics include one or more of a course type, a course subject matter, a syllabus format, a syllabus content.

23. The network computer of claim 19, wherein the one or more processors execute instructions that perform actions, further comprising:
determining the quality score based on one or more quality metrics associated with the skills model, wherein the one or more quality metrics are collected from one or more of a user-interface that provides a user satisfaction or one or more measured user interactions with the course profile or one or more learner profiles.

24. The network computer of claim 19, wherein the one or more processors execute instructions that perform actions, further comprising:
employing other course information associated with one or more courses to generate one or more skills models based on one or more of machine learning, experimental observation, or configurable heuristics.
